(19) United States
(12) Patent Application Publication
(10) Pub. No.: US 2013/0142999 A1
(43) Pub. Date: Jun. 6, 2013

(54) PLASTIC ARTICLE AND METHOD FOR MANUFACTURING SAME

(71) Applicants: ZHI-QING ZOU, Shenzhen City (CN); QIU-JIANG XU, Shenzhen City (CN); PO-FENG HO, Shindian (TW); HE-XIAN LIN, Shenzhen City (CN)

(72) Inventors: ZHI-QING ZOU, Shenzhen City (CN); QIU-JIANG XU, Shenzhen City (CN); PO-FENG HO, Shindian (TW); HE-XIAN LIN, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/440,523

(22) Filed: Apr. 5, 2012

(30) Foreign Application Priority Data
Dec. 3, 2011 (CN) 201110395486.X

(51) Int. Cl. B32B 3/30; B29C 45/14; B32B 7/02; B29D 11/00

(52) U.S. Cl. 428/161; 264/1.7

(57) ABSTRACT

A plastic article comprises a first plastic substrate and a second plastic substrate formed on the first plastic substrate. The refractive index of the first plastic substrate different then the refractive index of the second plastic substrate. The first plastic substrate comprises a first surface abutting the second plastic substrate. The first surface presented with a first pattern. The first pattern comprises a plurality of first convexes. A method for manufacturing the plastic articles is also provided.

### BACKGROUND

1. Technical Field

The exemplary disclosure generally relates to plastic articles and a method for manufacturing the plastic articles.

2. Description of Related Art

Repeatedly anodizing and laser engraving, insert molding, and ink printing are used to form a three-dimensional pattern on the housing of portable electronic devices, to improve appearance of housings. The housings may be presented with a colorful appearance, but cannot present with a three-dimensional, transparent and embossed pattern appearance like a crystal.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary plastic article and method for manufacturing the plastic article. Moreover, in the drawings like reference numerals designate corresponding parts throughout the several views. Wherever possible, the same reference numbers are used throughout the drawings to refer to the same or like elements of an embodiment.

FIG. 1 is a perspective view of an exemplary embodiment of plastic article.

FIG. 2 is a cross-sectional view of the plastic article of FIG. 1 taken along line II-II.

FIG. 3 is a schematic view of a molding tool for manufacturing the plastic article of FIG. 1.

FIG. 4 another schematic view of a molding tool for manufacturing the plastic article of FIG. 1.

### DETAILED DESCRIPTION

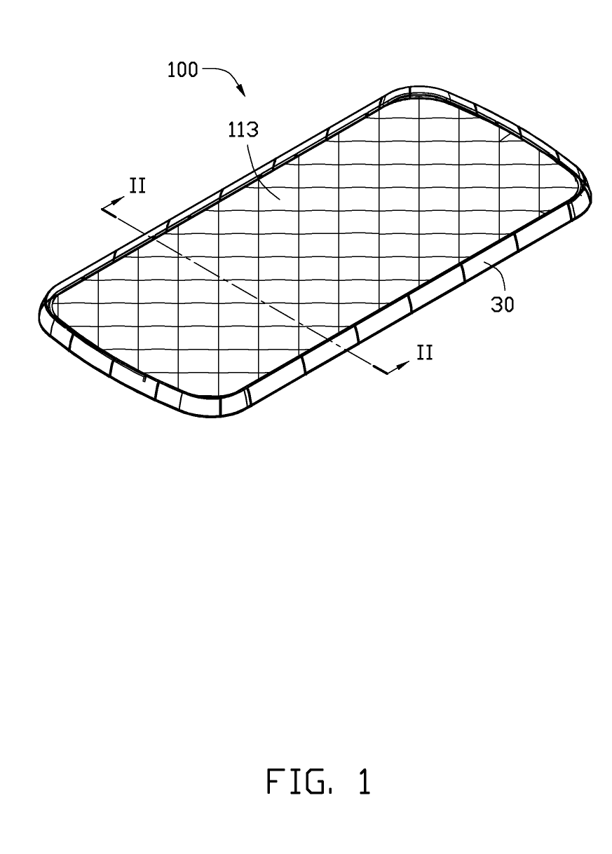

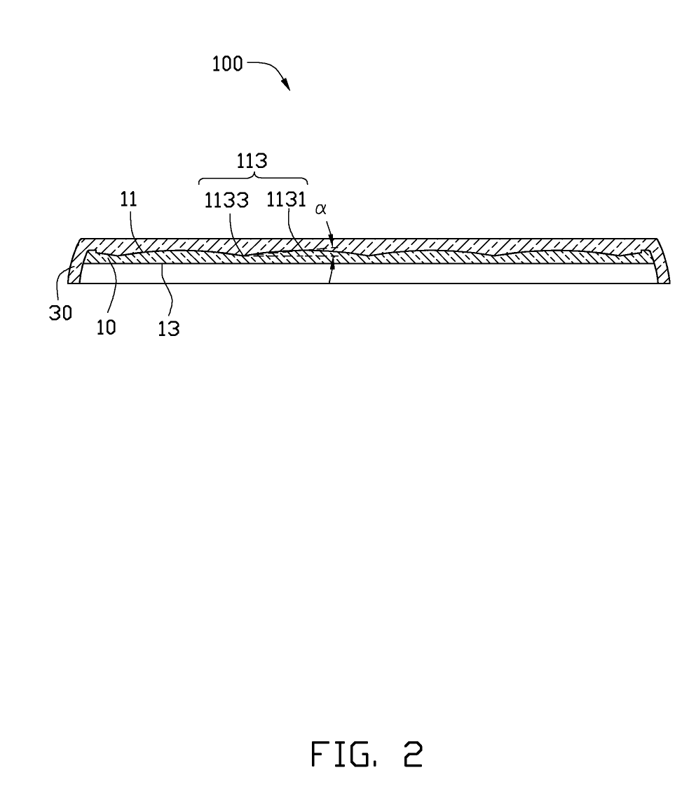

FIG. 1 shows an exemplary embodiment of a plastic article. Referring also to FIG. 2, a plastic article 100 comprises a first plastic substrate 10 and a second plastic substrate 30 formed on the first plastic substrate 10. The first plastic substrate 10 and the second plastic substrate 30 are respectively formed by different material to make a refractive index of the first plastic substrate 10 different then the refractive index of the second plastic substrate 30.

The first plastic substrate 10 comprises a first surface 11 abutting the second plastic substrate 30, and an opposite second surface 13. The first surface 11 is presented with a first pattern which is formed by injection moulding or laser engraving. The first pattern comprises a plurality of convexes 113. The projected area of the convexes 113 in the second surface 13 is about 0.8×0.8 mm² to about 2×2 mm², preferably 1×1 mm². The convexe 113 has a first highest point 1131 and a first lowest point 1133. The value of angle α between the line 1131-1133 and the horizontal is about 15° to about 35°. The height difference between the first highest point 1131 and first lowest point 1133 is about 0.3 mm to about 0.6 mm, preferably 0.5 mm.

The plastic article 100 can be formed by double color molding, insert molding, injection molding or reaction injection molding.

The first plastic substrate 10 can be transparent or translucent. The first plastic substrate 10 can be made of material selected from a group consisting of polycarbonate (PC), polymethyl methacrylate (PMMA), polyethylene (PE), polyamide (PA), acrylonitrile-butadiene-styrene plastics (ABS), Polyurethane(PU), a mixture of polycarbonate and glass fiber (PC+GF) and a mixture of polycarbonate and polyethylene terephthalate (PC+PET), preferably polymethyl methacrylate (PMMA) or polycarbonate (PC).

The second plastic substrate 30 can be transparent or translucent. The second plastic substrate 30 can be made of material selected from a group consisting of PMMA, PA, ABS, PU, epoxy resin, a mixture of PC+GF and a mixture of PC+PET, preferably epoxy resin.

Because the refractive index of the first plastic substrate 10 is different then the refractive index of the second plastic substrate 30, light will refract when light passes from the first plastic substrate 10 to the second plastic substrate 30. Thus, the user can view the embossed first pattern on the second plastic substrate 30. Additionally, since the first plastic substrate 10 and the second plastic substrate 30 are transparent or translucent, under the refraction of light, the first pattern is presented with a three-dimensional and transparent appearance like a crystal.

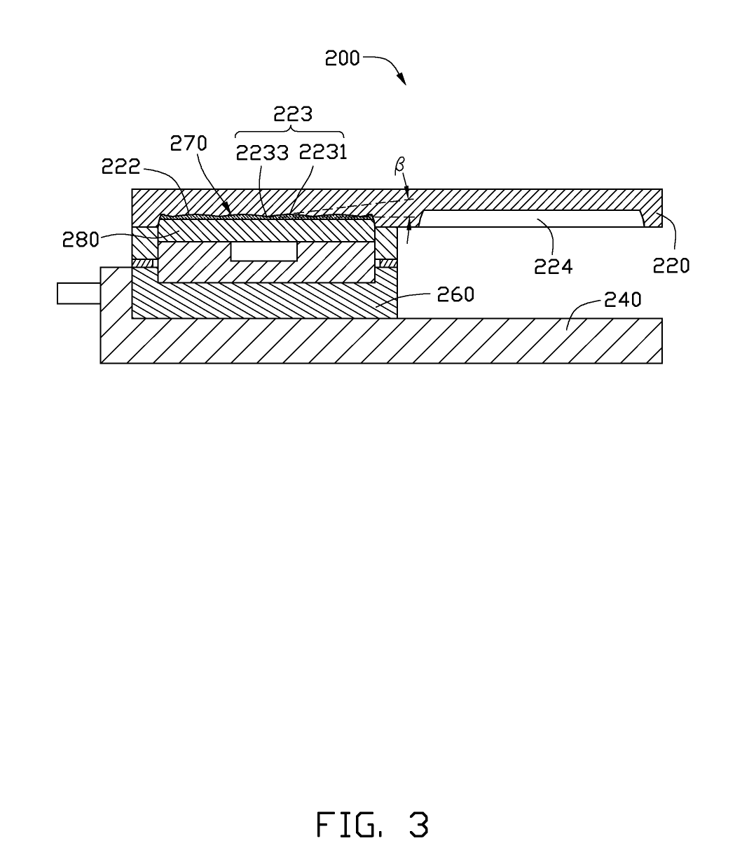

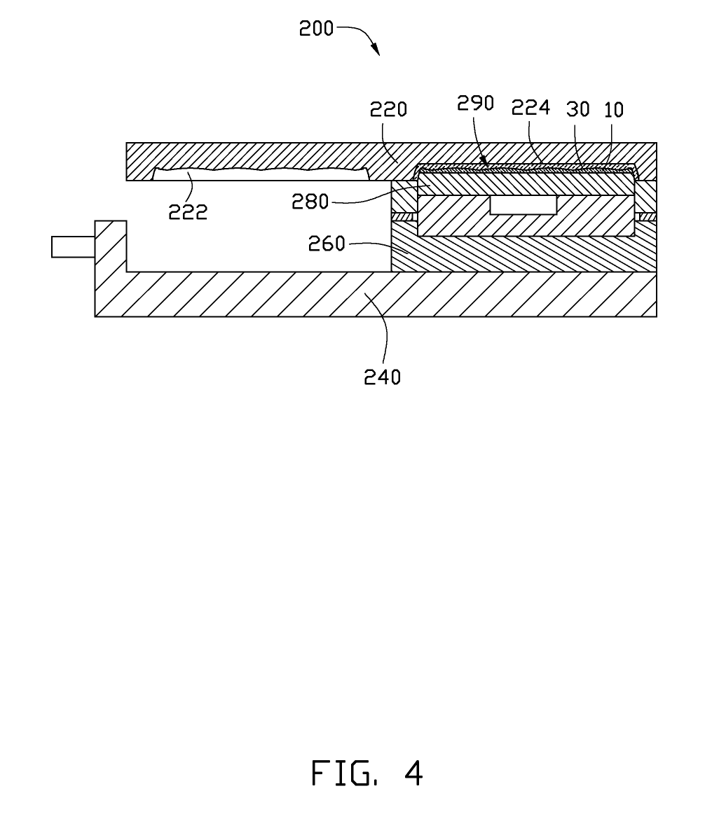

Referring to FIG. 3 and FIG. 4, a method for manufacturing the plastic article 100 may includes at least the following steps:

A molding tool 200 is provided. The molding tool 200 comprises an upper mold 220, a lower mold 240, a slide block 260 and a core 280. The upper mold 220 defines a first molding cavity 222 which used to forming the first plastic substrate 10, and a second molding cavity 224 which used to forming the second plastic substrate 30. The slide block 260 is slidably fixed to the lower mold 240. The core 280 is fixed to the slide block 260.

The upper mold 220 forms a second pattern on the inclined wall opposite to the core 280. The second pattern comprises a plurality of concaves 223. The projected area of the concaves 223 in the upper mold 220 is about 0.8×0.8 mm² to about 2×2 mm², preferably 1×1 mm². The concave 223 has a second highest point 2131 and a second lowest point 2133. The value of angle β between the line 2131-2133 and the horizontal is about 15° to about 35°. The height difference between the second highest point 2131 and second lowest point 2133 is about 0.3 mm to about 0.6 mm, preferably 0.5 mm.

The first plastic substrate 10 is formed. The first plastic substrate 10 formed by the following steps: sliding the slide block 260 to make the core 280 alignment with the first molding cavity 222 to form a first molding chamber 270 between the first molding cavity 222 and the core 280; and introducing a melted plastic material into the first molding chamber 270 by an injection unit; then cooling the molding tool 200, so that the melted plastic material will solidify to form the first plastic substrate 10. The first plastic substrate 10 comprises a first surface 11 abutting the inclined wall of the upper mold 220. The first surface 11 presented with a first pattern which is corresponding to the second pattern. The plastic material used to form the first plastic substrate 10 is selected from a group consisting of PC, PMMA, PE, PA, ABS, PU, a mixture of PC+GF and a mixture of PC+PET, preferably PMMA or PC.

Referring to FIG. 4, the slide block 260 is slid to make the core 280 alignment with the second molding cavity 224 to form a second molding chamber 290 between the first molding cavity 222 and the core 280. Then, introducing a melt plastic material into the second molding chamber 290 by an injection unit. Cooling the molding tool 200, so that the melted plastic material will solidify to form the second plastic substrate 30 on the first plastic substrate 10. The plastic material used to form the second plastic substrate 30 is selected from a group consisting of PMMA, PA, ABS, PU, epoxy resin, a mixture of PC+GF and a mixture of PC+PET, preferably epoxy resin.

In alternative embodiments, the molding tool 200 further comprises a vacuum pumping device (not shown) which is connected with the first molding chamber 270 and the second molding chamber 290. The vacuum pumping device is used to pump air out the first molding chamber 270 and the second molding chamber 290.

In alternative embodiments, the first molding chamber 270 and the second molding chamber 290 is not limited to set in the same molding tool, the first molding chamber 270 and second molding chamber 290 can be set in different molding tools according to actual needs in production.

In alternative embodiments, the first plastic substrate 10 can be formed by injection molding, and then the first pattern is formed on the first plastic substrate 10 by laser engraving.

In alternative embodiments, adjusting the size and spacing of the concaves 223 of the second pattern can make the plastic articles 100 presented with different shapes three-dimensional and transparent crystal embossed pattern.

It is to be understood, however, that even through numerous characteristics and advantages of the exemplary disclosure have been set forth in the foregoing description, together with details of the system and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A plastic article, comprising:
a first plastic substrate; and
a second plastic substrate formed on the first plastic substrate;
wherein a refractive index of the first plastic substrate different then the refractive index of the second plastic substrate, the first plastic substrate comprises a first surface abutting the second plastic substrate, the first surface presented with a first pattern, the first pattern comprises a plurality of first convexes.

2. The plastic article as claimed in claim 1, wherein the first plastic substrate further comprises a second surface opposite to the first surface, the projected area of the convexes in the second surface is 0.8×0.8 mm²to 2×2 mm².

3. The plastic article as claimed in claim 2, wherein the projected area of the convexes in the second surface is 1×1 mm².

4. The plastic article as claimed in claim 1, wherein the convexe has a first highest point and a first lowest point, the value of angle between the line of first highest point and a first lowest point and the horizontal is 15° to 35°.

5. The plastic article as claimed in claim 4, wherein the height difference between the first highest point and first lowest point is 0.3 mm to 0.6 mm.

6. The plastic article as claimed in claim 5, wherein the height difference between the first highest point and first lowest point is 0.5 mm.

7. The plastic article as claimed in claim 1, wherein the first plastic substrate is made of material selected from a group consisting of polycarbonate, polymethyl methacrylate, polyethylene, polyamide, acrylonitrile-butadiene-styrene plastics, Polyurethane, a mixture of polycarbonate and glass fiber and a mixture of polycarbonate and polyethylene terephthalate, preferably polymethyl methacrylate or polycarbonate.

8. The plastic article as claimed in claim 1, wherein the second plastic substrate is made of material selected from a group consisting of polymethyl methacrylate, polyamide, acrylonitrile-butadiene-styrene plastics, Polyurethane, epoxy resin, a mixture of polycarbonate and glass fiber and a mixture of polycarbonate and polyethylene terephthalate.

9. The plastic article as claimed in claim 1, wherein the first pattern is formed by injection moulding or laser engraving.

10. A method for manufacturing the plastic article comprising:
providing a first plastic substrate, the first plastic substrate comprising a first surface which presented with a first pattern, the first pattern comprising a plurality of first convexes;
forming a second plastic substrate on the first plastic substrate, wherein a refractive index of the first plastic substrate different then the refractive index of the second plastic substrate, the first plastic substrate comprises a first surface abutting the second plastic substrate, the second plastic substrate is transparent or translucent.

11. The method of claim 10, wherein the first plastic substrate is formed by the following steps: providing a molding tool, the molding tool comprises an upper mold, a lower mold, a slide block and a core, the upper mold defines a first molding cavity; the upper mold forms a second pattern on the inclined wall opposite to the core, the second pattern comprises a plurality of concaves, sliding the slide block to make the core alignment with the first molding cavity to form a first molding chamber between the first molding cavity and the core; introducing a melt plastic material into the molding chamber, and solidified the melt plastic material to form the first plastic substrate; the first surface presented with a first pattern which is corresponding to the second pattern.

12. The method of claim 11, wherein the concave in the upper mold is 0.8×0.8 mm² to 2×2 mm².

13. The method of claim 11, wherein the method of claim 9, wherein the concave in the upper mold is 1×1 mm².

14. The method of claim 11, wherein the concave has a second highest point and a second lowest point, the value of angle between the line of second highest point and a second lowest point and the horizontal is 15° to 35°.

15. The method of claim 14, wherein the height difference between the second highest point and second lowest point is 0.3 mm to 0.6 mm.

16. The method of claim 14, wherein the height difference between the second highest point and second lowest point is 0.5 mm.

17. The plastic article as claimed in claim 10, wherein the first plastic substrate is made of material selected from a group consisting of polycarbonate, polymethyl methacrylate, polyethylene, polyamide, acrylonitrile-butadiene-styrene plastics, Polyurethane, a mixture of polycarbonate and glass fiber and a mixture of polycarbonate and polyethylene terephthalate, preferably polymethyl methacrylate or polycarbonate.

18. The plastic article as claimed in claim 10, wherein the second plastic substrate is made of material selected from a group consisting of polymethyl methacrylate, polyamide, acrylonitrile-butadiene-styrene plastics, Polyurethane, epoxy resin, a mixture of polycarbonate and glass fiber and a mixture of polycarbonate and polyethylene terephthalate.
